(19) United States
(12) Patent Application Publication
(10) Pub. No.: US 2008/0283541 A1
(43) Pub. Date: Nov. 20, 2008

(54) Dispensing apparatus

(75) Inventors: Richard Warby, Norfolk (GB); Andrew Wright, Norfolk (GB); Simon Ingram, Northhamptonshire (GB)

Correspondence Address: SMITH, GAMBRELL & RUSSELL, 1130 CONNECTICUT AVENUE, N.W., SUITE 1130, WASHINGTON, DC, 20036, US

(73) Assignee: Consort Medical plc

(21) Appl. No.: 12/153,169

(22) Filed: May 14, 2008

(30) Foreign Application Priority Data
May 15, 2007 (GB) 0709383.4

(51) Int. Cl. A61J 7/00

(52) U.S. Cl. 221/4; 221/7

(57) ABSTRACT

Dispensing apparatus for delivery product from a dispensing container received in use within said dispensing apparatus, the dispensing apparatus comprising a housing defining a socket for said dispensing container and an outlet for product dispensed from said dispensing container, the apparatus further comprising a dose counting mechanism wherein at least a part of the dose counting mechanism is formed from copolyester.

This invention relates to improvements in or relating to dispensing apparatus, dispensing containers, and dispensing apparatus assemblies and in particular to such components wherein at least a part of the component is formed from copolyester.

Dispensing apparatus assemblies of the type used for dispensing products such as medicaments in aerosol or liquid form are well known. Dispensing apparatus assemblies have been designed to administer products by inhalation and sub-lingually. Typically such dispensing apparatus assemblies comprises a dispensing container received in a dispensing apparatus wherein the dispensing container includes a valve for controlling the actuation of the apparatus. The valve may be a continuous flow valve, but is more typically a metering valve wherein a metered dose of product is dispensed on each actuation of the valve. Such dispensing containers generally comprise a body in the form of a canister which stores the product to be dispensed and to which the valve is sealed. The dispensing apparatus generally comprises a housing, or actuator body, which is configured to contain the dispensing container, facilitate operation of the valve and direct the dispensed product out of the assembly in a manner in which it can be readily inhaled or swallowed.

According to the present invention there is provided a dispensing apparatus for delivering product from a dispensing container received in use within said dispensing apparatus, the dispensing apparatus comprising a housing defining a socket for said dispensing container and an outlet for product dispensed from said dispensing container, the apparatus further comprising a dose counting mechanism wherein at least a part of the dose counting mechanism is formed from copolyester.

It has been found that copolyester when used as at least part of a dispensing apparatus has many benefits. In particular the copolyester exhibits good impact-resistance.

Preferably at least a part of the housing is formed from copolyester. An advantage of forming at least a part of the housing from copolyester is that the impact-resistance of the material produces a housing which helps to protect any internal components of the apparatus if dropped. For example, breakage of potentially fragile components such as parts of dose counting mechanisms can be minimised or prevented.

The housing may be formed as a single copolyester moulding. Alternatively, the housing may comprise two or more components and at least one component is formed from copolyester.

The two or more components of the housing may be assembled together by one or more of a snap-fit mechanism, co-moulding, or bonding. A particular advantage of copolyester is that it is solvent bondable.

In a preferred embodiment the housing comprises an upper part and a lower part. Either or both parts may be formed from copolyester. Another advantage of copolyester is that it may be produced in a transparent form allowing, for example, the upper part of the housing to be transparent. This allows a user of the apparatus to easily determine whether a dispensing container is present and if so the nature of the contents by reading the label of the dispensing container without having to first remove the container from the housing.

The dose counting mechanism may comprise one or more annular counting rings formed from copolyester. In another example, the dose counting mechanism may comprise a sleeve member which is mountable onto said dispensing container, the sleeve member comprising means for transferring motion of said dispensing container into motion of the one or more annular counting rings, wherein the sleeve member is formed from copolyester.

Advantageously forming such components of a dose counting mechanism from copolyester increases the apparatus' resistance to shock impacts. A further advantage is that copolyester lends itself to moulding.

The present invention also provides a dispensing apparatus assembly as described above and a dispensing container.

The dispensing container may be pressurised. The dispensing container may comprise a metering valve.

Alternatively, the dispensing container may comprise a continuous flow valve.

Preferably the dispensing container contains a hydrofluorocarbon propellant such as HFA134a. An advantage of copolyester is that it has been found to exhibit low levels of extractibles in the presence of hydrofluorocarbon propellants. Thus, the material has been found particularly advantageous for use with pharmaceutical products where contaminant levels must be kept low. In addition, copolyester has good compatibility with ethanol and other alcohols which are often found as constituent parts of product formulations. Thus the copolyester is resistant to degradation when exposed to the formulation either during storage or during dispensation.

The dispensing apparatus assembly may be configured as an inhalation apparatus assembly. Alternatively, the dispensing apparatus assembly may be configured as a sub-lingual dispensing apparatus assembly.

The dispensing apparatus and assembly may be a pharmaceutical dispensing device, such as, for example, a pulmonary, nasal, or sub-lingual delivery device. A preferred use of the dispensing apparatus is as a pharmaceutical metered dose aerosol inhaler device. The term pharmaceutical, as used herein, is intended to encompass any pharmaceutical, compound, composition, medicament, agent or product which can be delivered or administered to a human being or animal, for example pharmaceuticals, drugs, biological and medicinal products. Examples include antiallergics, analgesics, bronchodilators, antihistamines, therapeutic proteins and peptides, antitussives, anginal preparations, antibiotics, anti-inflammatory preparations, hormones, or sulfonamides, such as, for example, a vasoconstrictive amine, an enzyme, an alkaloid, or a steroid, including combinations of two or more thereof. In particular, examples include isoproterenol [alpha-(isopropylaminomethyl)protocatechuyl alcohol], phenylephrine, phenylpropanolamine, glucagon, adrenochrome, trypsin, epinephrine, ephedrine, narcotine, codeine, atropine, heparin, morphine, dihydromorphinone, ergotamine, scopolamine, methapyrilene, cyanocobalamin, terbutaline, rimiterol, salbutamol, ipratropium bromide and salbutamol, flunisolide, colchicine, pirbuterol, beclomethasone, orciprenaline, fentanyl, and diamorphine, streptomycin, penicillin, procaine penicillin, tetracycline, chlorotetracycline and hydroxytetracycline, adrenocorticotropic hormone and adrenocortical hormones, such as cortisone, hydrocortisone, hydrocortisone acetate and prednisolone, insulin, cromolyn sodium, and mometasone, including combinations of two or more thereof.

The pharmaceutical may be used as either the free base or as one or more salts conventional in the art, such as, for example, acetate, benzenesulphonate, benzoate, bicarbonate, bitartrate, bromide, calcium edetate, camsylate, carbonate, chloride, citrate, dihydrochloride, edetate, edisylate, estolate, esylate, fumarate, fluceptate, gluconate, glutamate, glycollylarsanilate, hexylresorcinate, hydrobromide, hydrochloride, hydroxynaphthoate, iodide, isethionate, lactate, lactobionate, malate, maleate, mandelate, mesylate, methylbromide, methylnitrate, methylsulphate, mucate, napsylate, nitrate, pamoate, (embonate), pantothenate, phosphate, diphosphate, polygalacturonate, salicylate, stearate, subacetate, succinate, sulphate, tannate, tartrate, and triethiodide, including combinations of two or more thereof. Cationic salts may also be used, for example the alkali metals, e.g. Na and K, and ammonium salts and salts of amines known in the art to be pharmaceutically acceptable, for example glycine, ethylene diamine, choline, diethanolamine, triethanolamine, octadecylamine, diethylamine, triethylamine, 1-amino-2-propanol-amino-2-(hydroxymethyl)propane-1,3-diol, and 1-(3,4-dihydroxyphenyl)-2 isopropylaminoethanol.

The pharmaceutical will typically be one which is suitable for inhalation and may be provided in any suitable form for this purpose, for example as a solution or powder suspension in a solvent or carrier liquid, for example ethanol, or isopropyl alcohol. Typical propellants are HFA134a, HFA227 and di-methyl ether.

The pharmaceutical may, for example, be one which is suitable for the treatment of asthma. Examples include salbutamol, beclomethasone, salmeterol, fluticasone, formoterol, terbutaline, sodium chromoglycate, budesonide and flunisolide, and physiologically acceptable salts (for example salbutamol sulphate, salmeterol xinafoate, fluticasone propionate, beclomethasone dipropionate, and terbutaline sulphate), solvates and esters, including combinations of two or more thereof. Individual isomers such as, for example, R-salbutamol, may also be used. As will be appreciated, the pharmaceutical may comprise of one or more active ingredients, an example of which is flutiform, and may optionally be provided together with a suitable carrier, for example a liquid carrier. One or more surfactants may be included if desired.

Embodiments of the present invention will now be described, by way of example only, with reference to the accompanying drawings in which:

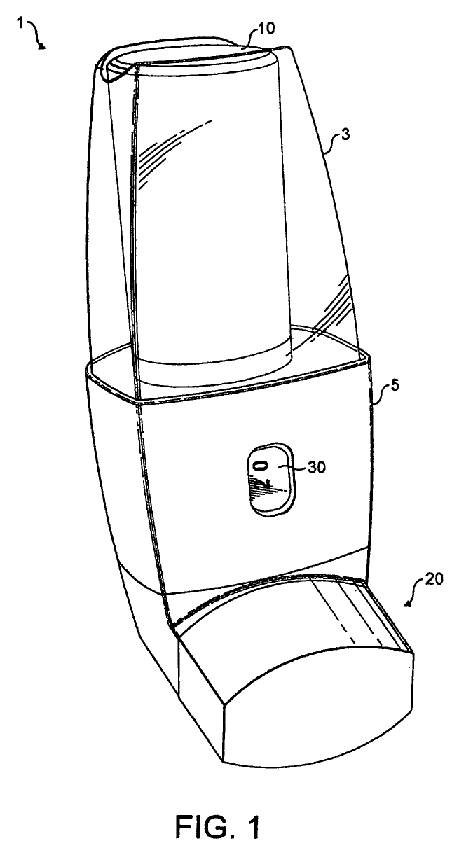

FIG. 1 is a perspective view of a dispensing apparatus assembly according to the present invention comprising a dispensing apparatus containing a pressurised dispensing container;

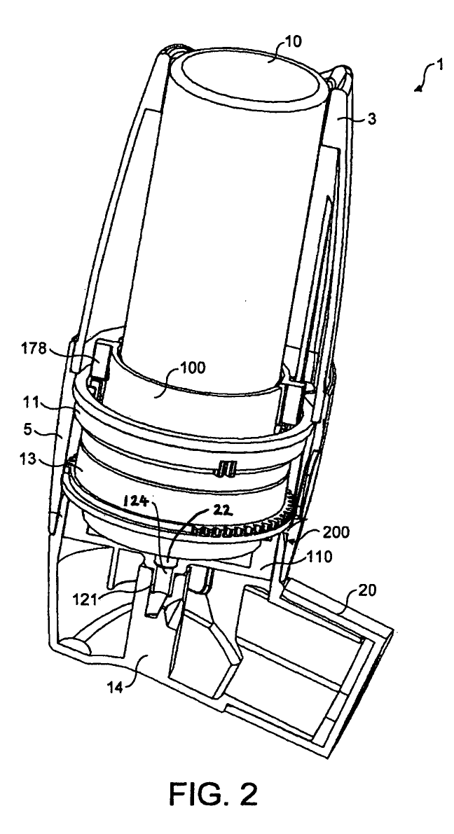

FIG. 2 is a part cross-sectional view of the dispensing apparatus assembly of FIG. 1;

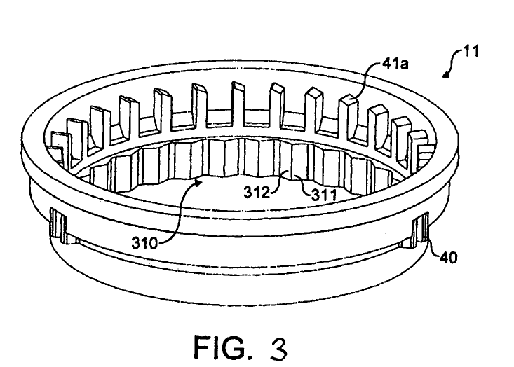

FIG. 3 is a perspective view of a first number ring of the dispensing apparatus of FIG. 1;

FIG. 4 is a perspective view of a cog forming part of the dispensing apparatus of FIG. 1;

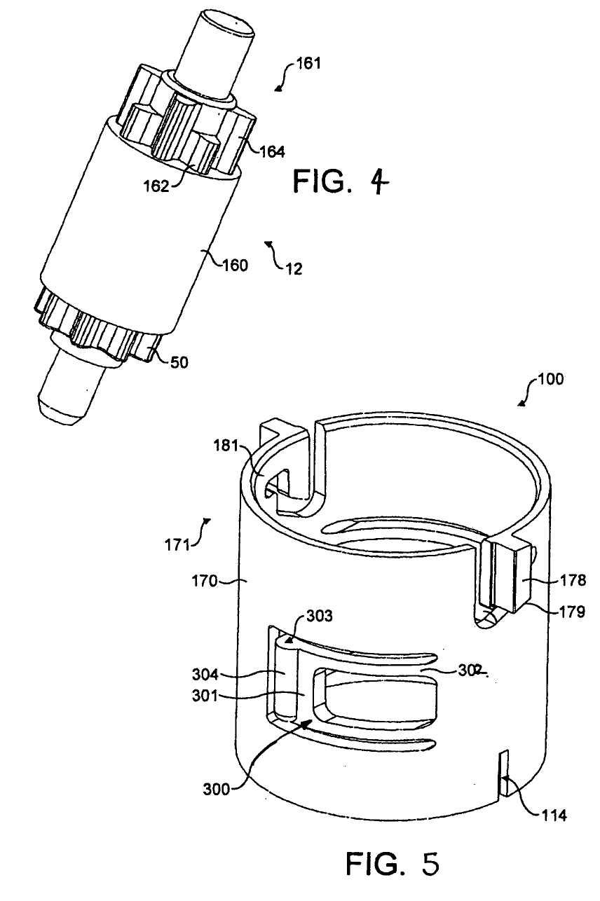

FIG. 5 is a perspective view of a sleeve forming part of the dispensing apparatus of FIG. 1; and

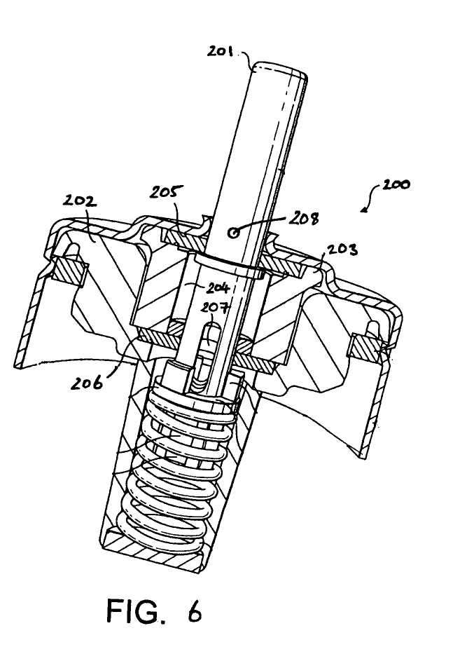

FIG. 6 is a cross-sectional view of a metering valve which forms part of the pressurised dispensing container of FIG. 1.

FIG. 1 shows a dispensing apparatus assembly according to the present invention indicated generally at 1, which comprises a dispensing apparatus, generally known as an actuator, and a pressurised dispensing container 10. The actuator comprises an upper body 3, a lower body 5 and a mouthpiece 20 which may be formed either integrally with the lower body 5 or may be formed as a detachable mouthpiece. A dust cap may be provided to cover the mouthpiece 20 when the apparatus is not in use as shown in FIG. 1. In use the dispensing apparatus 1 receives the pressurised dispending container 10 and the pressurised dispensing container 10 and the dispensing apparatus 1 together form a self-contained mechanism for dispensing a product to a user by inhalation.

According to the present invention the lower body 5 (optionally including the mouthpiece) and/or upper body 3 are formed from copolyester. A suitable copolyester is Eastar™ Copolyester MN006 from Eastman Chemical Co. of Tennessee, USA. The mouthpiece cap may also be formed from copolyester.

At its most straightforward, an actuator according to the present invention for use with a pressurised dispensing container of the type shown comprises internally a socket defined by the upper housing 3 and lower housing 5 in which a body of the pressurised dispensing container 10 is received and a valve stem receiving block 14 which is located towards a lower end of the lower body 5 as shown in FIG. 2. The valve stem receiving block 14 defines a conduit which is shaped to receive as a snug push-fit a valve stem 22 of a metering valve of the pressurised dispensing container 10. The conduit of the valve stem receiving block 14 comprises an orifice which is directed towards the outlet of the mouthpiece 20. Thus, the dispensing apparatus 1 provides an actuator housing which can be used to receive a pressurised dispensing container 10 and to facilitate actuation of the pressurised dispensing container 10 to dispense doses of product through the mouthpiece 20.

Typically, the pressurised dispensing container 10 will comprise a metering valve which dispenses a metered dose of product on each actuation of the valve. An example is metered dose inhaler products designed for containing medicament for treating chronic or acute asthma. Alternatively, the pressurised dispensing container 10 may be provided with a continuous flow valve which dispenses product for as long as the valve is held in an actuated position.

Nowadays when an actuator is used with a metered pressurised dispensing container it is preferable for the actuator to contain, in addition to the elements described above, a dose counting mechanism. FIG. 2 illustrates the internal construction of the upper body 3 and lower body 5 incorporating a dose counting mechanism. The dose counting mechanism allows accurate recordal and display of the number of doses dispensed from or remaining in the pressurised dispensing container 10. For the purposes of the present invention the precise design of the dose counting mechanism is not of primary importance and the following description is provided by way of example. The dose counting mechanism of FIG. 2 comprises first and second number rings 11,13, a cog 12 and a sleeve 100.

The lower body 5 houses the cog 12 and the first and second number rings 11, 13. The lower body 5 provides internal projections upon which the second number ring rests so that the rings may rotate during use. In particular, the second number ring 13 rests upon upfacing surfaces of the lower body 5 whilst the first number ring 11 rests and rotates during use on top of the second number ring 13. The cog 12 is rotatably mounted within the lower body 5 on a cylindrical axle and interacts with both first and second number rings 11, 13 in order to transmit motion at appropriate times between the first number ring 11 and the second number ring 13. In the apparatus shown the lower body 5 is provided at a lower end thereof with an axial protrusion 121 integral with the lower body 5. The axial protrusion 121 comprises a hollow elongate portion into which the valve stem 22 of the container is received. The hollow portion is provided with a narrowed constriction against which the valve stem 22 can abut when the dispensing apparatus is actuated. The hollow portion forms a conduit 124 that is in fluid communication with the outlet of the valve stem of the pressurised dispensing container when the container is inserted into the apparatus. The axial protrusion 121 itself protrudes from the lower end of the lower body 5 as shown in FIG. 2. The axial protrusion 121 is received as a snug fit within the valve stem receiving block 14 of the detachable mouthpiece. It should be noted that the valve stem 22 may be simply received directly in to the valve stem receiving block 14 where the mouthpiece is not detachable.

The lower body 5 and upper body 3 are connectable together using co-operating formations which are push-fit together. The first number ring 11 is provided with teeth having angled abutment surfaces 41a and teeth having angled abutment surfaces 311, 312 as shown in FIG. 3. The first number ring 11 also comprises at least one notch 40 positioned on an outer edge thereof. The first number ring 11 is also provided with a set of numbering not shown in the drawings such as a series of numerals from 0 to 9 in between each notch 40 so that after the ninth actuation of the apparatus 1 the notch 40 is in position to interact with the cog 12.

The cog 12 as shown in FIG. 4 is provided with one or more teeth separated by a non-toothed, cylindrical spacer 160. A first end 161 of the cog 12 includes four teeth 162 of reduced height and four teeth 164 of full height which in use interact with the first number ring 11. The teeth 50 at the second end of the cog 12 are all of full height and these teeth in use interact with teeth provided on the outside face of the second number ring 13 as shown in FIG. 2.

As shown in FIG. 5, the sleeve 100 comprises an open-ended cylinder 170 having an upper end 171 which can receive the pressurised dispensing container 10 and a lower end 172 which has a reduced diameter opening through which the valve stem 22 of the pressurised dispensing container can protrude but through which the body of the pressurised dispensing container 10 cannot pass. Thus in use the sleeve 100 receives and contains a portion of the dispensing container 10.

The sleeve 100 is provided with two sets of formations on its exterior surface. The sets of formations are arranged diametrically opposite one another (only one set of formations is shown in FIG. 5). Each set of formations comprises first, second and third formations. The first formation is provided at the lower end 172 in the form of notches 114. The second formation is provided above the notches 114 in the form of a tension arm 300. The tension arm 300 comprises a cantilevered portion 301 which is fixed to the sleeve 100 at a hinge point 302. The hinge point 302 marks the junction between the body of the sleeve 100 and the start of the cantilevered portion 301 of the tension arm 300. A distal end 303 of the tension arm 300 is provided with an outwardly directed projection 304. The outwardly directed projections 304 of the tension arm 300 can flex substantially radially inwards when pressure is applied to the projections in a radially inward direction. The third formation is provided at the upper end 171 in the form of a cantilevered projection 178. The cantilevered projection 178 comprises an elongated portion having an angled abutment surface 179 on its lower, distal end. The elongated portion of the cantilevered projection 178 is axially aligned with the projection. The elongated portion is joined to the cylindrical body of the sleeve 100 at a hinge point 181.

The lower body 5 is provided with a clear portion 30, or one or more apertures 30 through which portions provided with markings of the number rings 11, 13 are visible. The upper body 3 is transparent to allow a user to easily see the type of container 10 located in the apparatus 1.

In use, the internal components of the apparatus, such as the cog 5, the sleeve 100 and the number rings 11, 13 can be loaded into position within the apparatus 1 by separating the upper body 3 from the lower body 5. The internal projections 110 of the lower body 5 are received in the notches 114 of the sleeve 100 with the effect that the sleeve 100 is fixed rotationally relative to the lower body 5. The sleeve 100 is arranged to pass through the central holes/apertures of the number rings 11, 13. The upper body 3 is then attached to the lower body 5.

The pressurised dispensing container 10 can now be passed through the hole in the upper body 3 to be received in the sleeve 100. The valve stem 22 of the pressurised dispensing container 10 is received in the opening of the conduit 124 of the axial protrusion 121 as a relatively tight interference push-fit. When loaded, the number rings 11,13 are located around the container 10 as shown in FIG. 3.

The apparatus 1 is actuated by depression of the container 10. Depression of the container 10 causes the container 10 and sleeve 100 to move axially within the main body 5 to actuate the container 10. Actuation causes an amount of product to be dispensed from the container 10 by an opposite reaction force from the constriction in the axial protrusion 121 acting on the valve stem 22, which is inwardly retracted relative to the remainder of the metering valve such that an amount of product is dispensed from the valve stem 22 through the conduit 124 and the valve stem receiving block 14, from where it is dispensed as an aerosol through the mouthpiece 20 and inhaled by a user inhaling on the mouthpiece 20. Release of the container 10 causes the container to return to its starting position, owing to the internal spring bias of the metering valve, ready for subsequent dispensing.

Each actuation of the apparatus 1 causes the first number ring 11 to rotate a partial increment during the downstroke of the dispensing container owing to engagement of the angled abutment surface 179 of the cantilevered projection 178 with the angled abutment surfaces 41a the first number ring 11. This partial rotation of the first number ring 11 causes each outwardly directed projection 304 of each tension arm 300 to ride up an angled face 311 of respective protrusions 310. This movement is accommodated by the tension arms 310 as they flex radially inwards. The relative location of the angled abutment surfaces 41a and the projections 310 is such that when the down stroke of the sleeve 100 is completed the outwardly directed projections 304 of the tension arms 300 have ridden up the angled abutment surfaces 311 and over the peak of the projections 310 such that the outwardly directed projections 304 lie in contact with the angled abutment surfaces 312 of the projections 310. Thus, when the container is released, and the sleeve 100 consequently moves back on its up stroke, the completion of the incremental rotation of the first number ring 11 is achieved by the biasing force of the outwardly directed projections 304 of the tension arms 300 on the angled abutment surfaces 312 as the tension arms 300 try to return to their unstressed position. This biasing force completes the rotation of the first number ring 11 such that the outwardly directed projections 304 of the tension arms 300 lie in the neighbouring trough between the projections 310 after one actuation.

Every ten actuations of the apparatus 1 cause the notch 40 to pass the cog 12, the effect of this being that one of the full height teeth 164 of the upper row of teeth is caught in the notch 40 as it rotates, this rotation causes a corresponding rotation of the cog 12 in the opposite sense. As a consequence, the second number ring 13 is caused to rotate in the same sense as the first number ring 11 by interaction of the teeth 50 on the bottom of the cog 12 and the teeth of the second number ring 13. Therefore, it can be seen that every actuation of the apparatus causes the value of the numbering visible through the one or more apertures 30 to be decreased or augmented by a value of one.

Any of the first and second number rings 11, 13, cog, 12 and sleeve 100 may be advantageously formed from copolyester. A particular benefit of using moulded copolyester for the number rings 11, 13 is that a transparent ring is easily producable which allows for novel combinations of alphanumeric characters and colours to be used to indicate the dose count to the user. In addition, the impact performance of copolyester allows for the robust components to be produced.

Copolyester is used to form one or more components of the metering valve of the pressurised dispensing container 10. A typical metering valve is shown in FIG. 6. The precise design of the metering valve is not of primary importance and the following description is provided by way of example.

The metering valve 200 comprises a valve stem 201 co-axially slidable within a valve member 202. The valve member is cup shaped and contains a cylindrical chamber body 203. An annular metering chamber 204 is thus defined between the faces of the chamber body 203 and the valve stem 201. An outer seal 205 extends between the chamber body 203 and the valve stem 201 to seal an outer end of the metering chamber 204. Likewise, an inner seal 206 extends between either or both of the valve member 202 and chamber body 203 and the valve stem 201 to seal an inner end of the metering chamber. The valve stem 201 is axially movable within the metering chamber and comprises ports for controlling flow of fluid into and out of the valve. A filling port 207 is provided at an inner end of the valve stem 201 and is in fluid communication with bulk product stored in the container 10 to which the valve is connected in use. The filling port 207 comprises an elongate slot or slots in the valve stem 201 which bridge the inner seal 206 in the non-actuated position of FIG. 6. Thus one end of the filling port 207 is located within the metering chamber 204 whist the other end is in fluid communication with the bulk product. Thus in the position of FIG. 6 the metering chamber 204 can be filled with product from the bulk volume. The valve stem 201 further comprises an outlet port 208 at an outer end which communicates with an outlet bore of the valve stem. In the position of FIG. 6 the outlet port 208 is outside the metering chamber 204 and sealed therefrom by the outer seal 205. However, in use the valve stem 201 can be depressed to move the outlet port 208 into the annular metering chamber allowing the metered dose therein to be discharged to atmosphere via the outlet bore. At the same time, the filling port 207 is moved fully past the inner seal thereby sealing off the bulk storage volume from atmosphere.

Any of the valve member 202, chamber body 203 and valve stem 201 may be formed from copolyester.

1. Dispensing apparatus for delivering product from a dispensing container received in use within said dispensing apparatus, the dispensing apparatus comprising a housing defining a socket for said dispensing container and an outlet for product dispensed from said dispensing container, the apparatus further comprising a dose counting mechanism wherein at least a part of the dose counting mechanism is formed from copolyester.

2. Dispensing apparatus as claimed in claim. I wherein at least a part of the housing is formed from copolyester.

3. Dispensing apparatus as claimed in claim 2 wherein the housing is formed as a single copolyester moulding.

4. Dispensing apparatus as claimed in claim 2 wherein the housing comprises two or more components and at least one component is formed from copolyester.

5. Dispensing apparatus as claimed in claim 4 wherein the two or more components of the housing are assembled together by one or more of a snap-fit mechanism, co-moulding, or bonding.

6. Dispensing apparatus as claimed in claim 4 or claim 5 wherein the housing comprises an upper part and a lower part.

7. Dispensing apparatus as claimed in claim 1 wherein the dose counting mechanism comprises one or more annular counting rings formed from copolyester.

8. Dispensing apparatus as claimed in claim 7 wherein the dose counting mechanism comprises a sleeve member which is mountable onto said dispensing container, the sleeve member comprising means for transferring motion of said dispensing container into motion of the one or more annular counting rings, wherein the sleeve member is formed from copolyester.

9. Dispensing apparatus assembly comprising a dispensing apparatus as claimed in claim 1 and a dispensing container.

10. Dispensing apparatus assembly as claimed in claim 9 wherein the dispensing container is pressurised.

11. Dispensing apparatus assembly as claimed in claim 9 or claim 10 wherein the dispensing container comprises a metering valve.

12. Dispensing apparatus assembly as claimed in claim 9 or claim 10 wherein the dispensing container comprises a continuous flow valve.

13. Dispensing apparatus assembly as claimed in claim 9 or claim 10 wherein the dispensing container contains a hydrofluorocarbon propellant such as HFA134a.

14. Dispensing apparatus assembly as claimed in claim 9 or claim 10 configured as an inhalation apparatus assembly.

15. Dispensing apparatus assembly as claimed in claim 9 configured as a sub-lingual dispensing apparatus assembly.
